(19) United States
(12) Patent Application Publication
(10) Pub. No.: US 2016/0195723 A1
(43) Pub. Date: Jul. 7, 2016

(54) Methods and apparatus for reflected display of images

(71) Applicant: Seebright Inc., Santa Cruz, CA (US)

(72) Inventors: John Murray, Winter Park, FL (US); Robert Rossi, San Jose, CA (US); Stephen Eckhardt, White Bear Lake, MN (US)

(21) Appl. No.: 14/988,615

(22) Filed: Jan. 5, 2016

Related U.S. Application Data
(60) Provisional application No. 62/099,581, filed on Jan. 5, 2015.

(51) Int. Cl. G02B 27/01; G02B 17/08

(52) U.S. Cl. CPC G02B 27/0172; G02B 17/0832; G02B 27/0176; G02B 2027/0132; G02B 2027/0163; G02B 2027/0154

(57) ABSTRACT

A head-mounted display includes two sets of mirrors. The head-mounted display also includes a rigid structure. The rigid structure supports an image source and supports the two sets of mirrors. The apparatus is worn on the head of a user. Each mirror set comprises three or more curved mirrors. In some cases, each set of mirrors includes a mirror at cheek level, a mirror at brow level, and a mirror in front of an eye. For each mirror set, light travels from the cheek mirror, to the brow mirror, to the mirror in front of the eye. Each set of mirrors rotates an image displayed by the image source and relays the image to an eye of the user. The image undergoes a net rotation of substantially ninety degrees between the image source and the eye.

### RELATED APPLICATION

This application is a non-provisional of, and claims the benefit of the filing date of, U.S. Provisional Patent Application No. 62/099,581, filed Jan. 5, 2015.

### FIELD OF THE TECHNOLOGY

The present invention relates generally to a head-mounted display with multiple curved mirrors, which curved mirrors taken together rotate an image.

### SUMMARY

In exemplary implementations of this invention, two sets of mirrors in a head-mounted display (HMD) present images to a user's eyes. One set of mirrors (“right mirror system”) reflects light to the user's right eye. The other set of mirrors (“left mirror system”) reflects light to the user's left eye. Each set of mirrors comprises three curved mirrors. Light travels from an image source positioned in front of a user's forehead, reflecting via these mirror sets to the user's eyes. In some cases, the images displayed are stereoscopic.

In illustrative implementations, a head-mounted display (HMD) includes an image source, or bears the weight of an image source that is releasably attached to the HMD. For example, in some cases, the image source comprises a flat or curved display screen. In other cases, the image source comprises a micro-projector. When the HMD is worn by a user, the image source is positioned such that it is in front of the user's forehead and is touching or adjacent to the forehead. For example, in some implementations: (a) the image source is the display screen of a smartphone; (b) the smartphone is touching or slightly in front of the user's forehead; and (c) the smartphone is positioned such that its display screen is facing down (and thus is approximately perpendicular to the user's forehead).

In illustrative implementations, the HMD includes the right mirror system and left mirror system. When the HMD is worn by the user, the right mirror system is located to the right of the user's mid-sagittal plane (i.e., median plane), and the left mirror system is located to the left of the user's mid-sagittal plane. The right and left mirror system each comprise three mirrors. In each of these sets, the three mirrors are disposed such that light from an image source (at forehead level) travels down to a first curved mirror at cheek level (the “cheek mirror”), then reflects from the cheek mirror and travels to a second curved mirror at eyebrow level (the “brow mirror”), then reflects from the brow mirror and travels to a third curved mirror at eye-level (the “view mirror”), and then reflects from the view mirror and travels to an eye. The view mirror has an orientation and position that are similar to that of a conventional eyeglass lens. However, the view mirror is larger than most eyeglass lenses.

In some cases, the view mirror is partially transmissive and partially reflective (e.g., half-silvered), and the user looks at the view mirror to watch an Augmented Reality display. In other cases, the view mirror is fully reflective, and the user looks at the view mirror to watch an immersive display.

In illustrative implementations, the HMD includes one or more barriers or other optical elements, configured such that the user's right eye does not see the images being presented to the user's left eye via the left mirror system, and the user's left eye does not see the images being presented to the user's right eye via the right mirror system. The image source includes two regions. The images presented to the left eye are displayed on one of these regions, and the images presented to the right eye are displayed on the other region. Alternatively, two separate display screens are used, one for images bound for the left eye, the other for images bound for the right eye.

In some implementations, the images presented to the eyes via the mirror systems are stereoscopic. At any given time, the image presented to the user's right eye differs from the image presented to the user's left eye in such a way as to create an appearance of depth by stereopsis. For example, in some cases, the right and left images differ slightly in their vantage point. This difference in vantage point is similar to binocular disparity between right and left eyes, and thus the user perceives depth due to stereopsis.

In illustrative implementations, the image source and two sets of mirrors obscure only a small portion of the user's face. For example, if a smartphone that is about 0.27 inches deep is used as the image source, and the HMD supports the smartphone at forehead level with its screen facing down, then the smartphone itself obscures only a small strip of the user's forehead that is about 0.27 inches deep when viewed by another person looking at the user face-to-face. (In illustrative implementations, the HMD includes a structure to support the smartphone. This support structure, too, obscures a small portion of the face. However, orienting the smartphone with its screen facing down tends to minimize the amount of the face obscured by this support structure).

The fact that the image source and mirror sets leave most of the user's face unobscured is advantageous. For example, a user wearing the HMD and watching an augmented reality display has only a small region of his face obscured, thereby making his facial expressions visible and facilitating social interaction.

In illustrative implementations, the HMD (including the mirrors, mirror carriages, and support structure for the HMD) is configured such that a user of the HMD simultaneously wears both conventional eyeglasses and the HMD, without the eyeglasses interfering with the HMD or vice versa.

In some cases, a positive lens is positioned in an optical path between the image source and the cheek mirror. Typically, the positive lens is positioned adjacent to a flat display screen (e.g., attached to the display screen of a smartphone). For example, if the display screen is facing down, the positive lens is typically attached to, and positioned beneath, the display screen. The positive lens facilitates the use of smaller mirrors. For example, a positive lens reduces the size of the beam at the cheek mirror, thus allowing a smaller cheek mirror. This in turn allows the cheek mirror to be located closer to the user's cheek. Locating the view mirror closer to the user's cheek tends to increase field of view. For example, the positive lens may comprise a plano-convex mirror, biconvex mirror, a Fresnel positive lens, or a set of multiple lens which together function as a positive lens.

In some cases, the positive lens is decentered. For example, a decentered lens may shift the beam of light rays closer to the cheek of the user. This allows the cheek mirror to be brought closer to the cheek, and thus allows the view mirror to be brought closer to the user's eye. Bringing the view mirror closer to the user's eye increases the field of view.

In illustrative implementations, the mirror system rotates an image. In some cases, a real image is displayed on a region of the image source. This real image is the optical object of the mirror system. The light from this region is reflected by the mirror system, producing a virtual image that is viewed by a user's eye. In some cases, the orientation of the real image and the orientation of the virtual image differ by substantially 90 degrees. However, this invention is not limited to rotation by substantially 90 degrees. Instead, this invention may rotate light by a different angle. For example, in some cases: (a) this invention rotates light by substantially 180 degrees' and (b) thus the orientation of the real image and the orientation of the virtual image differ by substantially 180 degrees.

For example, in some cases involving substantially 90 degree rotation: (a) a region of the image source displays a real image on the image source; (b) light that is emitted from this region along an optical axis of the mirror system travels in a first direction immediately after leaving this region; (d) light that strikes an eye along an optical axis of the mirror system travels in a second direction immediately before striking the eye; and (e) the first and second directions differ by substantially 90 degrees.

For example, in some cases involving substantially 180 degree rotation: (a) a region of the image source displays a real image on the image source; (b) light that is emitted from this region along an optical axis of the mirror system travels in a first direction immediately after leaving this region; (d) light that strikes an eye along an optical axis of the mirror system travels in a second direction immediately before striking the eye; and (e) the first and second directions differ by substantially 180 degrees.

This invention has many practical applications. For example, in illustrative implementations, this invention is used for 3D gaming, augmented reality, virtual reality, or 3D stereoscopic video.

The description of the present invention in the Summary section hereof is just a summary. It is intended only to give a general introduction to some illustrative implementations of this invention. It does not describe all of the details of this invention. Likewise, the description of this invention in the Field of the Technology section is not limiting; instead it identifies, in a general, non-exclusive manner, a field of technology to which some illustrative implementations of this invention generally relate. Likewise, the Field of Endeavor section is not limiting; instead, it identifies, in a general, non-exclusive manner, a field of endeavor to which some illustrative implementations of this invention generally relate. Likewise, the Title of this document does not limit the invention in any way; instead the Title is merely a general, non-exclusive way of referring to this invention. This invention may be implemented in many other ways, in addition to those described in the Title and in the Summary, Field of Technology and Field of Endeavor sections. The Title and the Summary, Field of Technology and Field of Endeavor sections do not limit the scope of this invention in any way.

### BRIEF DESCRIPTION OF THE DRAWINGS

FIG. 1 shows a perspective view of a user wearing a head-mounted display (HMD).

FIG. 2 shows a side perspective view of an HMD.

FIG. 3 shows a bottom perspective view of an HMD.

FIG. 4 shows a perspective view of an HMD.

FIG. 5A shows a side view of an HMD.

FIG. 5B shows eye tracking apparatus and an actuator for controlling inter-pupillary distance.

FIG. 5C shows a decentered lens refracting light to move light closer to a user's cheek.

FIG. 5D shows a decentered lens refracting light to move light further away from a user's cheek.

FIG. 5E shows a lens positioned over a display screen.

FIG. 5F shows two lenses positioned over two different parts of a display screen.

FIG. 5G shows a wedge prism refracting light to move light further away from a user. FIG. 5H shows a wedge prism refracting light to move light further away from a user. FIG. 5I shows a single wedge prism over a display screen. FIG. 5J shows two wedge prisms covering two different parts of a display screen.

FIG. 5K shows a display screen with two display regions, each covering 50% of the screen.

FIG. 5L shows a display screen with two display regions, each covering less than 50% of the screen.

FIG. 6 shows a bottom view of an HMD

FIG. 7A shows a centered positive lens attached to a rectangular display screen.

FIG. 7B shows a decentered positive lens attached to a rectangular display screen.

FIG. 7C shows a centered positive lens attached to an ellipsoidal display screen.

FIG. 7D shows a decentered positive lens attached to an ellipsoidal display screen.

FIG. 7E shows a centered Fresnel lens.

FIG. 7F shows a decentered Fresnel lens.

FIG. 8A shows a filter on a front surface of a view mirror.

FIG. 8B shows a Mangin mirror.

FIG. 9A shows a non-interference zone.

FIG. 9B shows a frame zone.

FIG. 10A shows a planar image.

FIG. 10B shows a curved image.

FIG. 11 shows a method of controlling distortion.

FIG. 12 shows another method of controlling distortion.

FIG. 13A shows a mirror that is symmetric about an axis.

FIG. 13B shows a mirror that is symmetric about a plane.

FIG. 13C shows a mirror with no axes of symmetry.

FIG. 14A shows a wireless remote controller.

FIG. 14B shows a wireless remote controller being tracked by a head-mounted display.

FIG. 15A shows four mirrors that cause light to rotate by substantially 180 degrees.

FIG. 15B shows a prism refracting light.

The above Figures show some illustrative implementations of this invention, or provide information that relates to those implementations. However, this invention may be implemented in many other ways.

### DETAILED DESCRIPTION

In illustrative implementations of this invention, an optical system includes one or more sets of curved mirrors. Each set of mirrors forms an exit pupil and produces a virtual image. When the HMD is worn on a user's head, the exit pupil is located at the optical entrance pupil of an eye of the user and the virtual image is in front of the user. Thus, the optical exit pupil of each mirror set coincides spatially with the optical entrance pupil of a human eye. (As is well known, the optical entrance pupil of the eye is inside the eye, slightly behind the physical pupil of the eye.) Each set of mirrors produces a virtual image in front of the user. In some cases, the image source comprises a display screen of a smartphone, cellphone, or other mobile computing device (MCD). Any display technology may be used for the display screen. For example, in some cases, the display screen comprises an LCD (liquid crystal display) screen, an AMOLED (active matrix organic light emitting diode) screen, or an AMLCD (active matrix liquid crystal display) screen.

In illustrative implementations, each set of mirrors rotates an image by about 90 degrees. For example, in some cases, an image is displayed by a smartphone display screen that is at forehead level and facing down (parallel to the ground, and approximately perpendicular to the user's forehead). The image is rotated by a set of mirrors by approximately 90 degrees, such that the image, after being rotated, is displayed to the user on a plane or curved surface in front of the user.

In illustrative implementations, each mirror set includes curved mirror surfaces. In some cases, the mirror set includes both concave and convex surfaces to reduce aberrations and create the aforementioned exit pupil and image. For example, in some cases, the image size is changed from an initial rectangular area that is approximately 55 mm wide (in the source, e.g., the display screen of a smartphone) to a rectangular area that may appear to be over 1 meter wide. Because the image is virtual, it cannot be measured directly. The exit pupil is large enough to allow eye rotation sufficient to see the entire curved surface of the forward-facing view mirror.

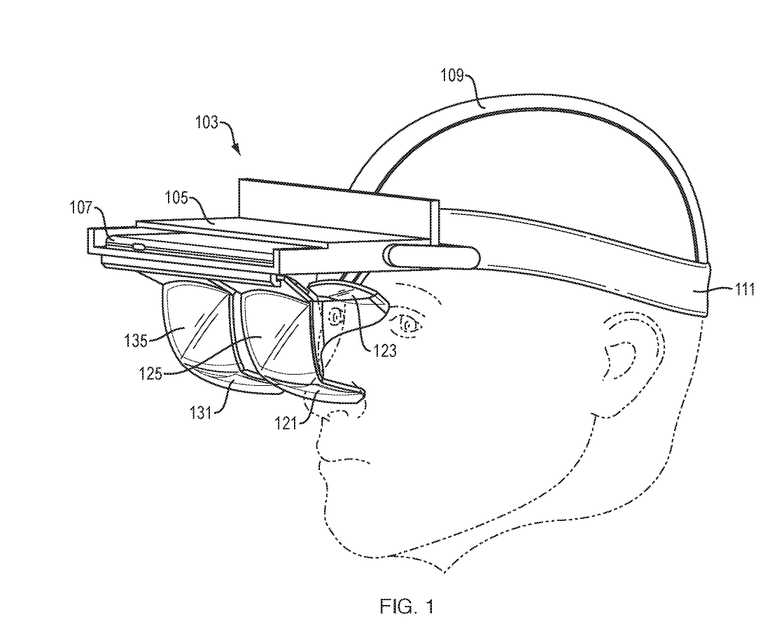

FIG. 1 shows a perspective view of a user wearing a head-mounted display (HMD) 103, in an illustrative implementation of this invention. In the example shown in FIG. 1, most of the user's face is unobscured, so that the user's facial expression can be easily seen. The HMD 103 includes a rigid support structure 105 which supports an image source 107. For example, the image source 107 may comprise a flat panel display screen (such as the display screen of a smartphone) or a projector (such as a micro-projector). In FIG. 1, structure 105 is attached to straps 109, 111 that are worn over or around the user's head and that hold structure 105 in place relative to the head. Alternatively, in some cases, rigid support structure 105 is part of, comprises, or is attached to, a helmet, hat or other headwear worn on the user's head.

In FIG. 1, image source 107 (e.g., a display screen) faces downward such that light from the image source is traveling downward at the instant that it exits the image source. The HMD includes a right mirror system and a left mirror system. Each of these mirror systems include a cheek mirror, brow mirror and view mirror. For example, the left mirror system includes cheek mirror 121, brow mirror 123 and view mirror 125. The right mirror system includes cheek mirror 131, brow mirror 133 (not shown in FIG. 1), and view mirror 135.

In the example shown in FIG. 1, each of the mirrors (e.g., 121, 123, 125, 131, 133, 135) is curved. In some cases, one or more of the mirrors (e.g., 121, 123, 125, 131, 133, 135) includes a reflective surface with a concave curvature. In some cases, one or more of the mirrors (e.g., 121, 123, 125, 131, 133, 135) includes a reflective surface with a convex curvature.

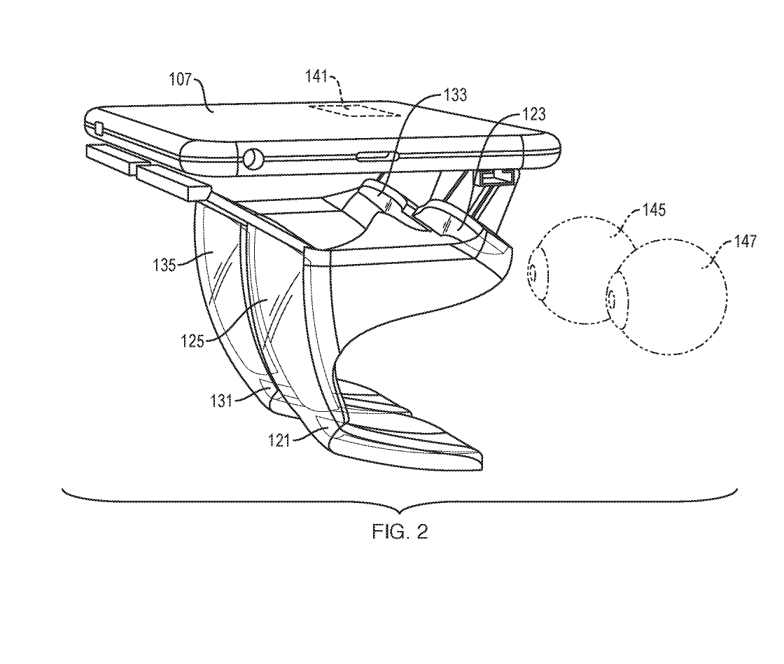

FIG. 2 shows a side perspective view of an HMD, in an illustrative implementation of this invention. A mobile computing device (e.g., smartphone) is attached to and supported by the HMD. In the example shown in FIG. 2, the mobile computing device (MCD) is the image source in the HMD. The MCD is oriented approximately perpendicular to the user's forehead, with its display screen facing down. The right view mirror 135 is viewed by the user's right eye 145; and the left view mirror 125 is viewed by the left eye 147.

FIG. 3 shows a bottom perspective view of an HMD, in an illustrative implementation of this invention. In FIG. 3, images displayed by a screen on a mobile computing device (e.g., a smartphone) are reflected via two mirror systems to the user's eyes 145, 147. In some cases, the displayed images are stereoscopic. Each mirror system includes a cheek area mirror 121, 131, a brow area mirror 123, 133, and a view mirror 125, 135. The right mirror system is housed in the right carriage located on the right side of the user's face. The left mirror system is housed in the left carriage located on the left side of the user's face. The display screen of the mobile computing device includes two regions. Light from one region 165 travels to the user's right eye 145. Light from another region 167 travels to the user's left eye 147. Region 165 is the optical object of the right mirror system. Region 167 is the optical object of the left mirror system.

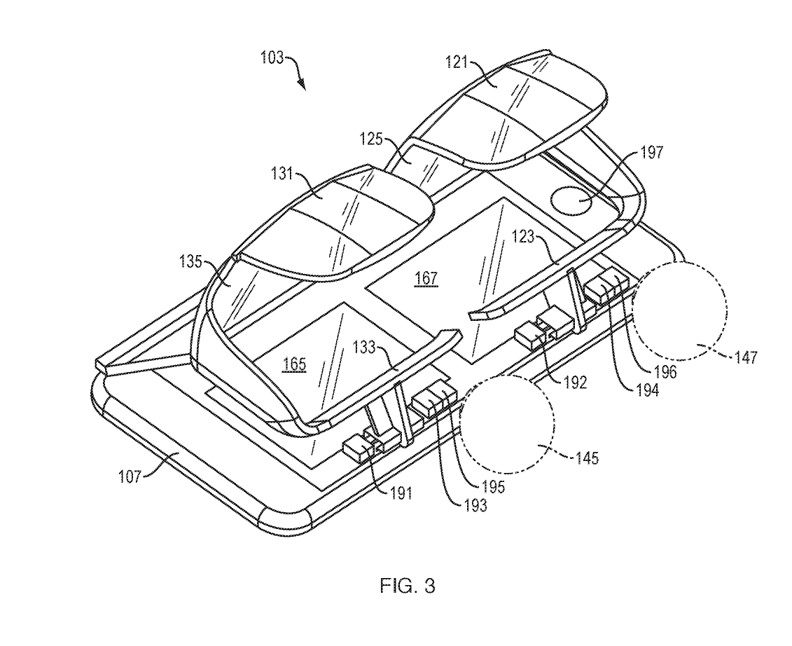

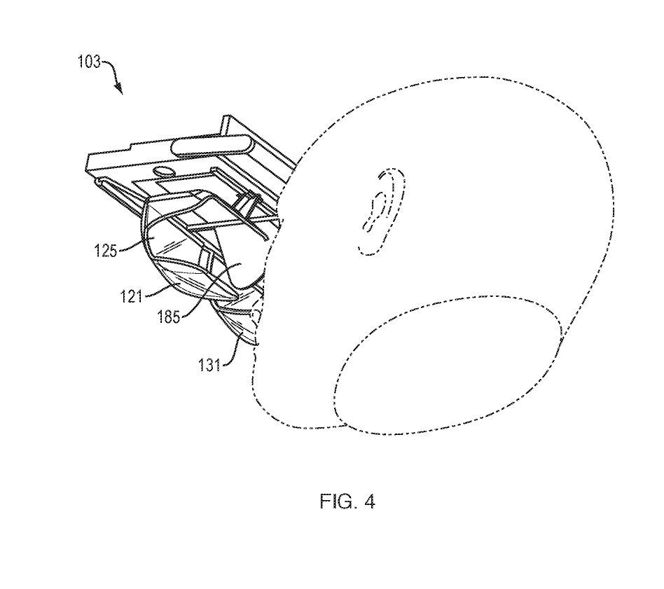

FIG. 4 shows a perspective view of an HMD. In FIG. 4, an optical barrier 185 prevents the right eye from seeing images displayed to the left eye, and vice versa.

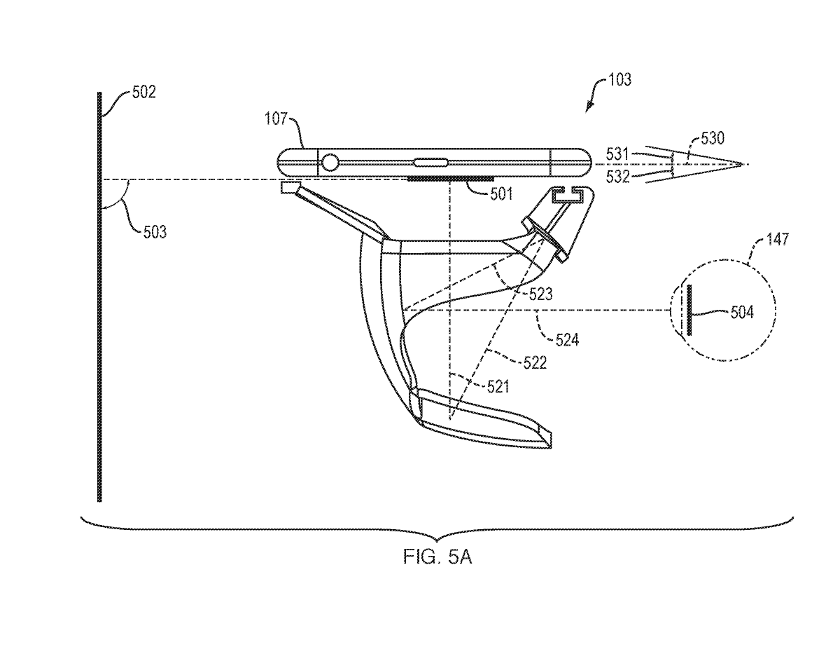

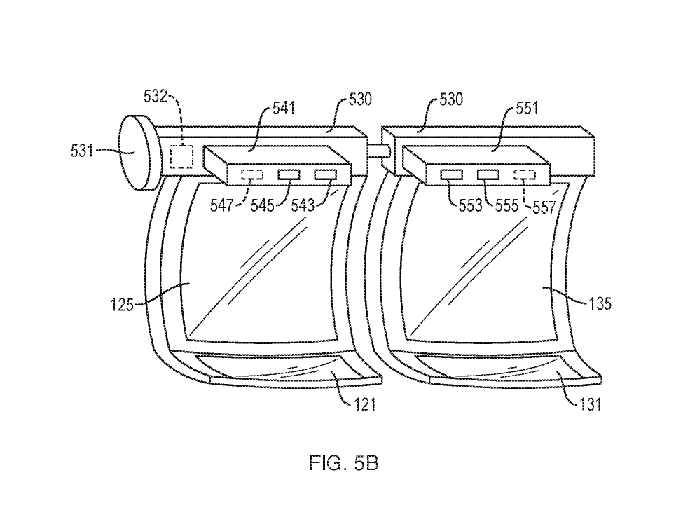

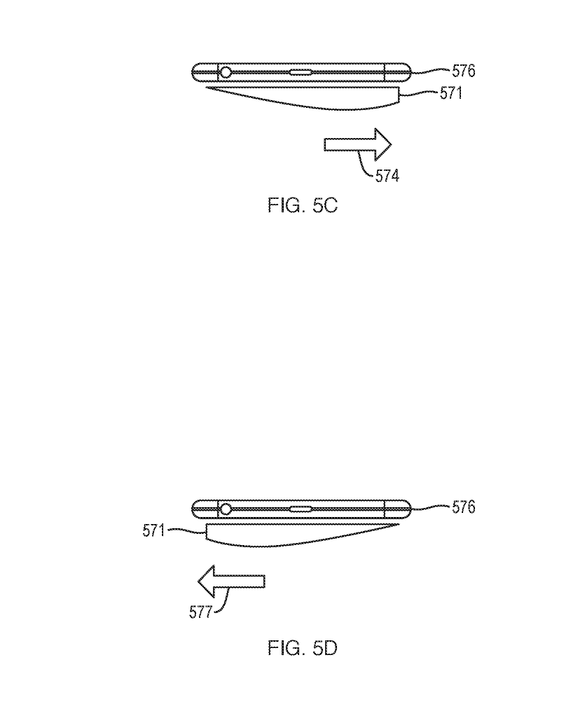

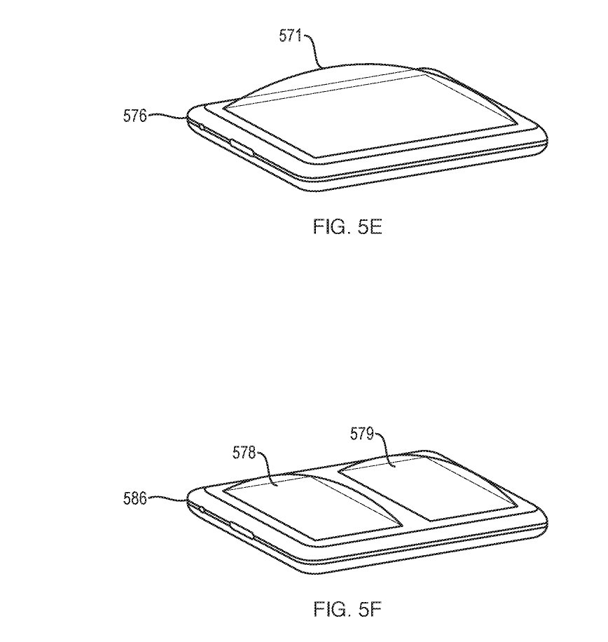

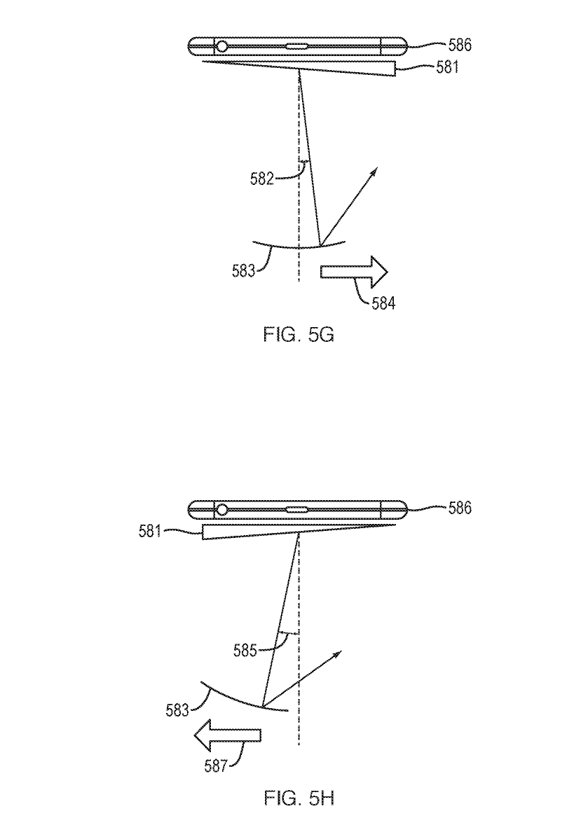

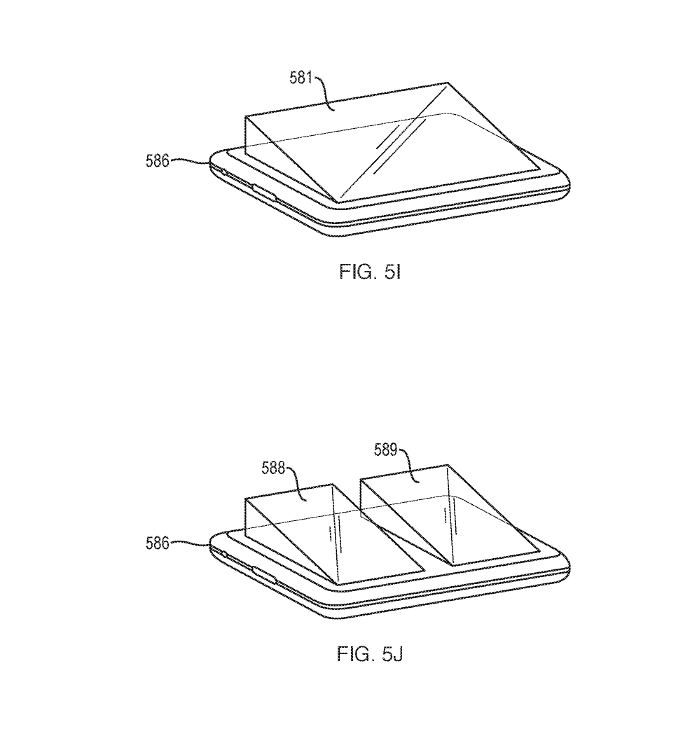

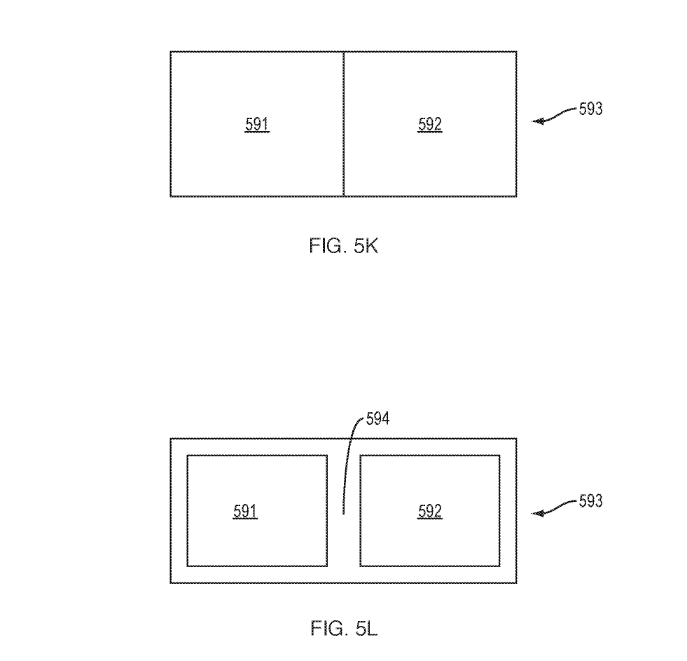

FIG. 5A shows a side view of an HMD 103, in an illustrative implementation of this invention. Light travels from image source (e.g., a display screen of a smartphone) 107 to an eye 147 via optical path 521, 522, 523, 524. This optical path is folded by reflections off of three mirrors. As a result, an image of the image source is rotated by substantially ninety degrees by the time that it is presented to the eye.

A real image 501 displayed on the image source is substantially horizontal. The real image 501 is the optical object of the mirror system. Real image 501 is oriented in a horizontal plane. A virtual image 502 produced by reflected light from the mirrors is oriented a vertical plane.

The three mirrors produce a large virtual image 502 in front of the mirror set. Virtual image 502 is not shown to scale in FIG. 5A: virtual image 502 is larger than it appears to be in FIG. 5A. Also, the distance of virtual image 502 from the three mirrors is not shown to scale in FIG. 5A: virtual image 502 is further from the three mirrors than it appears to be in FIG. 5A.

When the HMD is worn on the user's head: (a) the exit pupil of the three mirror optical system is located at position 504; and (b) the entrance pupil of the eye (which is inside the eye) is also located at position 504. Thus, when the HMD is worn on the user's head, the exit pupil of the three mirrors spatially coincides with the entrance pupil of the eye.

In FIG. 5A, the image source (e.g., a display screen of a smartphone) 107 is substantially horizontal. For example, in some cases, the image source is horizontal (parallel to horizontal plane 530). In other cases, the image source is at a positive angle 531 relative to horizontal, which positive angle is less than or equal to 10 degrees. In other cases, the image source is at a negative angle 532 relative to horizontal, which negative angle is greater than or equal to negative ten degrees.

In the example shown in FIG. 5A, the three mirrors rotate the image by substantially ninety degrees. Thus, a real image 501 that is substantially horizontal is rotated by three mirrors, to produce a virtual image 502 that is substantially vertical, which virtual image is seen by eye 147. In FIG. 5A, angle 503 is substantially ninety degrees. Angle 503 is the angle between real image 501 and virtual image 502.

FIG. 5B shows eye-tracking apparatus and an actuator for controlling inter-pupillary distance (IPD), in an illustrative implementation of this invention. In FIG. 5B, the eye tracking apparatus includes a left component 541 for tracking gaze of the left eye and a right component 551 for tracking gaze of the right eye. The eye-tracking apparatus includes infrared (IR) sensors 543, 553, IR light sources (e.g., LEDs) 545, 555 and microprocessors 547, 557. The actuator 530 includes an electrically-powered motion actuator 532 (e.g., an electric motor or electro-active polymer) for actuating motion. Alternatively, actuator 530 includes a dial 531 whereby a user imparts mechanical motion to the actuator. The actuator 530 translates the mirror carriages, thereby increasing or decreasing IPD.

FIG. 5C shows a decentered lens refracting light to move light closer to a user. In FIG. 5C, decentered lens 571 is positioned such that it refracts light emitted by an image source (e.g., a display screen or projector) 576, causing the light to move closer to the user's cheek. Arrow 574 indicates a direction toward the user's cheek. Shifting the light beam closer to the cheek allows the cheek mirror to be brought closer to the user's cheek. Bringing cheek mirror closer to the cheek in turn allows the view mirror to be brought closer to the user's eye, thereby increasing field of view.

FIG. 5D shows a decentered lens refracting light to move light further away from a user. In FIG. 5D, decentered lens 571 is positioned such that it refracts light emitted by the image source (e.g., a display screen or projector) 576, causing the light to move further away from the user's cheek. Arrow 577 indicates a direction away from the user's cheek. Shifting the light beam further from the cheek allows the cheek mirror to be positioned further from the cheek. This may be advantageous in some cases, including to increase the depth of the frame zone or non-interference zone.

FIG. 5E shows a lens 571 positioned adjacent to a display screen 576.

FIG. 5F shows two lenses 578, 579 positioned adjacent to two different parts of a display screen.

FIG. 5G shows a wedge prism refracting light to move light closer to a user. In FIG. 5G, wedge prism 581 is oriented such that it refracts light emitted by an image source (e.g., a display screen or projector) 586, causing the light to move closer to the user's cheek. In FIG. 5G, angle 582 is the angle by which the wedge prism 581 deflects the light closer to the user's cheek. As a result, cheek mirror 583 may be brought closer to the user's cheek. Arrow 584 indicates a direction toward the user's cheek. Bringing cheek mirror 583 closer to the user's cheek in turn allows the view mirror (e.g., 125, 135) to be brought closer to the user's eye, thereby increasing field of view.

FIG. 5H shows a wedge prism refracting light to move light further away from a user. In FIG. 5H, wedge prism 581 is oriented such that it refracts light emitted by the image source (e.g., a display screen or projector), causing the light to move further away from the user's cheek. In FIG. 5H, angle 585 is the angle by which the wedge prism 581 deflects the light farther away from the user's cheek. As a result, cheek mirror 583 may be moved further away from the user's cheek. Arrow 587 indicates a direction away from the user's cheek. Bringing the cheek mirror 583 further from the user's cheek may be advantageous in some cases, including to increase the depth of the frame zone or non-interference zone.

FIG. 5I shows a single wedge prism 581 positioned over a display screen 586.

FIG. 5J shows two wedge prisms 588, 589 covering two different parts of a display screen 586.

FIG. 5K shows a display screen with two display regions 591, 592, each covering 50% of a display screen 593, in an illustrative implementation of this invention.

FIG. 5L shows a display screen with two display regions 591, 592, each covering less than 50% of a display screen 593, in an illustrative implementation of this invention. An optical barrier separates light bound for the right and left eyes, respectively. However, this optical barrier occupies a portion 594 of the display screen 593.

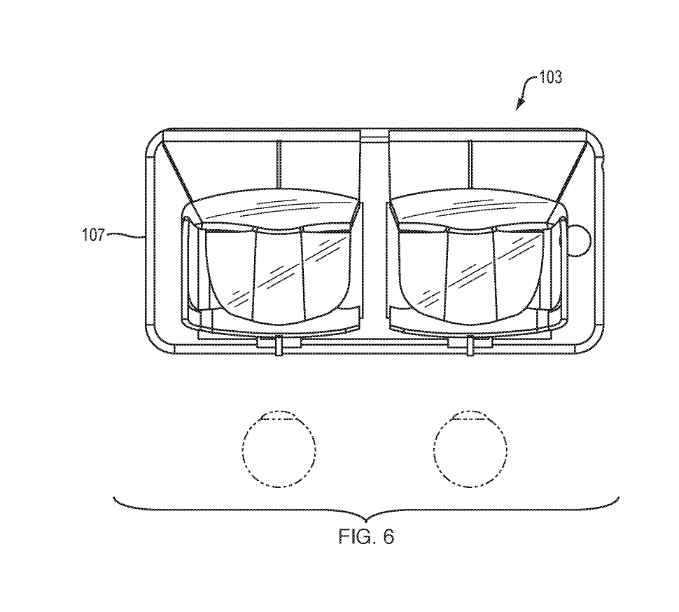

FIG. 6 shows a bottom view of an HMD 103, in an illustrative implementation of this invention.

### Positive Lens

In some cases, a positive lens is positioned in an optical path between the image source and the cheek mirror. Typically, the positive lens is positioned adjacent to a flat display screen (e.g., attached to the display screen of a smartphone). For example, if the display screen is facing down, the one or more lenses are typically attached to, and positioned beneath, the display screen. The positive lens allows the use of smaller mirrors. For example, a positive lens reduces the size of the beam at the cheek mirror, thus allowing a smaller cheek mirror. This in turn allows the cheek mirror to be located closer to the user's cheek. Locating the view mirror closer to the user's cheek tends to increase field of view. For example, the positive lens may comprise a plano-convex mirror, biconvex mirror, a Fresnel positive lens, or a set of multiple lens which together function as a positive lens.

In some cases, the positive lens is decentered. For example, a decentered lens may shift the beam of light rays closer to the cheek of the user. This allows the cheek mirror to be brought closer to the cheek, and thus the view mirror to be brought closer to the user's eye. Bringing the view mirror closer to the eye increases the field of view.

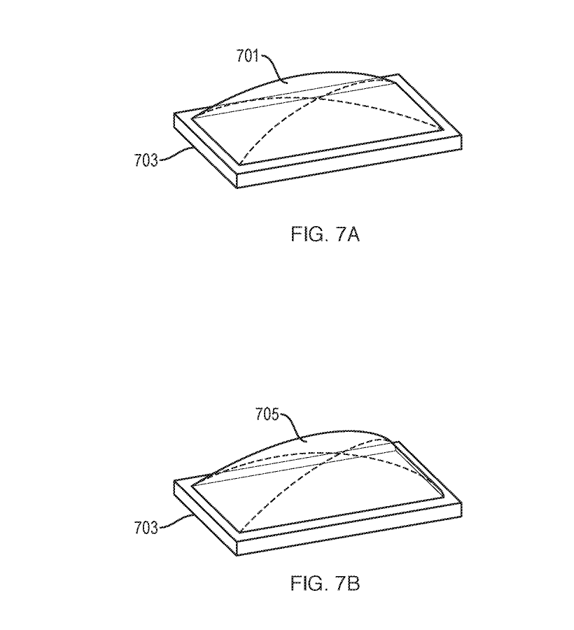

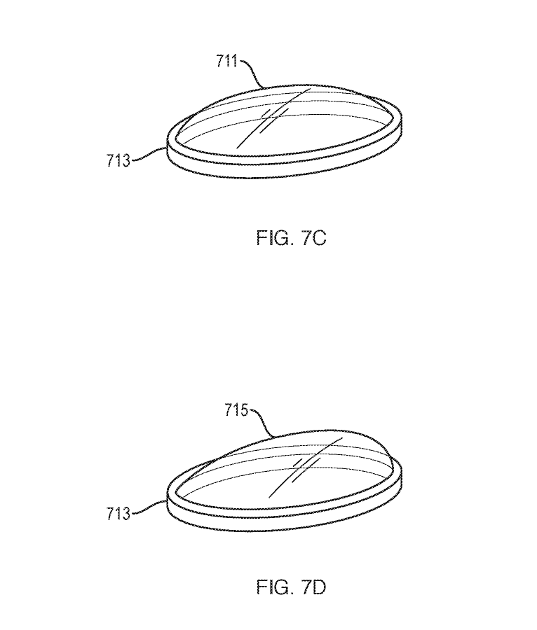

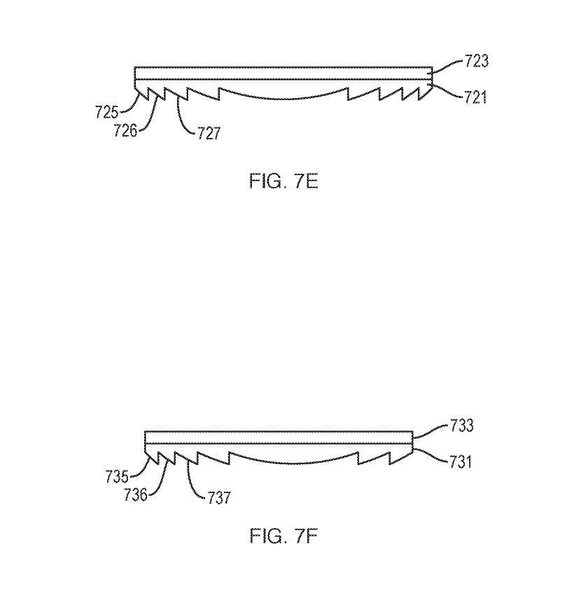

FIG. 7A shows a centered positive lens 701 attached to a rectangular display screen 703.

FIG. 7B shows a decentered positive lens 705 attached to a rectangular display screen 703.

FIG. 7C shows a centered positive lens 711 attached to an ellipsoidal display screen 713.

FIG. 7D shows a decentered positive lens 715 attached to an ellipsoidal display screen 713.

As is apparent from FIGS. 7C and 7D, this invention is not limited to rectangular image sources. For example, the image source (e.g., a display screen) may have a display region that has an overall shape that is rectangular, square, oval, ellipsoidal or circular.

FIG. 7E shows a positive, centered Fresnel lens 721 attached to a display screen 723. The Fresnel lens 721 includes plano-convex facets (e.g., 725, 726, 727).

FIG. 7F shows a positive, decentered Fresnel lens 731 attached to a display screen 733. The Fresnel lens 731 includes plano-convex facets (e.g., 735, 736, 737).

### Image Source

In illustrative implementations, the image source is an electronic display screen of a mobile computing device (such as a smartphone). For example, in some cases the image source is a smartphone display screen comprising a single contiguous screen. In other cases, the image source comprises two separate display panels, one each for the left and right eyes. In alternative implementations, the image source comprises a micro-projection device, or a system of two micro-projection devices.

In some cases, in which one contiguous LCD display is used: (a) a first portion not exceeding one half of the display screen displays a first image directed at a right eye; and (b) a second portion not exceeding one half of the display screen displays a second image directed at a left eye. In some other cases, where two display screens (or two micro-projectors) are used, each unit is the source of an image presented to the left and right eyes respectively.

In some implementations, a full half section of a display screen emits light bound to a particular eye. However, in many cases, the center of a display screen is not used due to occlusion by a barrier element that prevents one eye from accessing imagery that is intended for the other. In some cases, the image area for each half (in the case of a contiguous display screen) is a square or a rectangle (e.g., with an aspect ratio of 4:3 or 16:9). Alternatively, two flat or curved panel displays or micro-projectors are used, with a source dedicated to each eye. One or more computers (e.g., onboard the MCD) execute a software program that, among other things: (1) controls, via the display driver, the visual display on the display screen; (2) causes appropriate images to be displayed in the areas of the display that emit light bound for the right and left eyes, respectively; and (3) controls the size, orientation and position of each image.

In the apparatus depicted in FIG. 3, the carriage assemblies (which house the left and right mirror systems) are centered on the eyes of the user. The distance between the right and left mirror systems is adjustable, in order to accommodate different inter-pupillary distances of different users. One or more computers (e.g., onboard the MCD) execute software that controls the position of the two images. In FIG. 3, two boxes 165, 167 are shown in the display screen. These boxes symbolize the bounding areas of two images that are propagated through the left and right eye mirror optical assemblies respectively. The boxes are included for purposes of explanation, but would not appear in actual operation. Instead, in actual operation, two images of that size appear on the display screen and the surrounding area is made darker (e.g., black).

In some cases, images are displayed on only a subset of the available display panel area. The unused space on the display screen allows adjustment of inter-pupillary distance via lateral movement of the right and left carriages, as described herein.

In illustrative implementations, when the HMD is being worn by a user, the display screen of the image source (e.g., a smartphone) faces straight down. In other cases, the display screen is tilted plus or minus 8 degrees from facing straight down. In other cases, the display screen is tilted plus or minus 10 degrees from facing straight down.

### Mirror System

In illustrative implementations, the right mirror system and left mirror system each comprise three mirrors. All of the mirrors are curved. The mirror systems achieve an approximate 90 degree rotation and inverse magnification (reduction of image size) of images displayed by the image source. In illustrative implementations, the rotation is between 80 degrees and 100 degrees. Preferably, the rotation is between 82 degrees and 98 degrees.

In illustrative implementations, an image displayed by an image source (e.g., a display screen of a smartphone) travels to a cheek mirror, then reflects from the cheek mirror and travels to a brow mirror, then reflects from the brow mirror and travels to a view mirror, then reflects from the brow mirror and travels to an eye.

In illustrative implementation, the view mirror comprises either a fully reflective mirror, or a see-through mirror (half silvered). The image is reflected from the view mirror into the pupil of the human eye.

In illustrative implementations, the mirrors are either first surface or second surface mirrors.

In some cases, a film 801 is applied to the front surface of the view mirror 800, to filter (and reduce the intensity of) light from the user's surroundings, thereby creating a desirable contrast between the natural image seen through the half silvered mirror and the superimposed image originating from the display via the reflective mirrors.

In some cases, one or more of the mirrors contain a lens element (e.g., Mangin mirror) to compensate for distortion. In other cases, the HMD does not include any Mangin mirror.

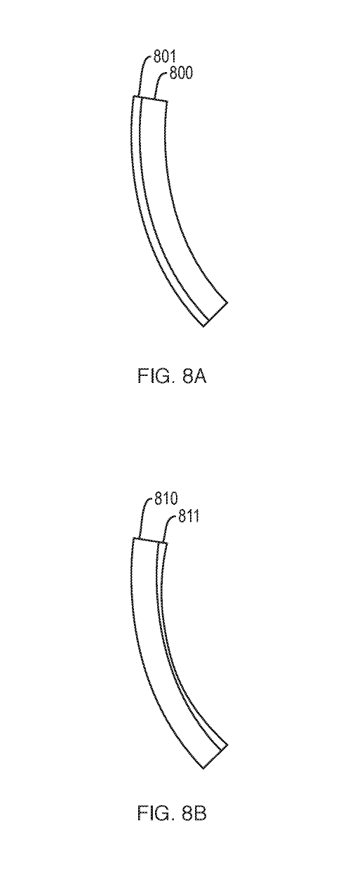

FIG. 8A shows a film 801 attached to the front of a view mirror 800, in an illustrative implementation of this invention. FIG. 8B shows a Mangin mirror that comprises a reflective surface 810 attached to a meniscus lens 811.

In some implementations, the shape of each mirror in the right and left mirror assemblies is defined by a Zernike polynomial with an order greater than or equal to six.

This invention is not limited to using three mirrors in the right and left mirror assemblies, respectively. In alternative embodiments, the number of mirrors in each mirror assembly (e.g., the right mirror assembly and left mirror assembly, respectively) is four, five, six, seven, eight, nine, or a number greater than nine. In some cases, the number of mirrors in each mirror assembly is odd. In some cases, the number of mirrors in each mirror assembly is even. An odd number of mirrors may produce a so-called “mirror image” of the display that appears reversed. An even number of mirrors may produce an image that does not appear reversed and is not a so-called “mirror image”. In some cases, two curved mirrors are included in each mirror assembly.

A practical advantage of using three or mirrors is to obtain a sharp image.

### Non-Interference Zone and Frame Zone

A problem that confronted the inventors of this invention is how to be sure that, if the user wears conventional eyeglasses at the same time as the HMD, the conventional eyeglasses and HMD do not interfere with each other. That is, the problem was how to ensure that (a) both the conventional eyeglasses and HMD fit on the user's head at the same time; (b) the eyeglasses (including the eyeglass lenses and frame) do not obstruct an internal optical path of the HMD, and (c) the HMD (including the mirrors, mirror carriages, and support structure for the HMD) does not obstruct light from the eyeglass lenses reaching the user's eyes. In illustrative implementations, this problem is solved with a “non-interference zone”. The “non-interference zone” is a volume near the user's eyes, in which the conventional eyeglass lenses are positioned when the conventional eyeglasses are worn by the user. The HMD is configured such that, when the HMD is worn by the user: (a) no hardware component of the HMD intersects the volume of the non-interference zone; and (b) no optical path internal to the HMD (e.g., from one mirror of the HMD to another mirror of the HMD) intersects this volume. (Of course, however, light that exits the HMD for presentation to the user intersects this volume).

For example, in some cases, the volume of the non-interference zone consists of two non-contiguous cuboids, where each cuboid is positioned in front of an eye and has the following dimensions: 30 mm forward from the eye's pupil, 30 mm up from the eye's pupil, and 3.15 mm to the right and 15 mm to the left of the eye's optical axis. (For purposes of the preceding sentence, the position of the optical axis is determined as if the user were looking “straight ahead” in a horizontal direction).

Alternatively, other dimensions and shapes of the non-interference zone are used. For example, in some cases, the shape of the non-interference zone is defined (at least in part) by a curved surface.

In addition, in illustrative implementations, the HMD is configured such that it does not interfere with the “frame zone” of conventional eyeglass frames. The “frame zone” is a volume occupied by the eyeglass frames (including the eyewires, bridge, brow bar, pad arms, nose pads, hinges, end pieces, temples and temple tips of the frames). The frame zone overlaps the non-interference zone. In illustrative implementations, the HMD is configured such that, when the HMD is worn by the user: (a) no hardware component of the HMD intersects the volume of the frame zone; and (b) no optical path internal to the HMD (e.g., from one mirror of the HMD to another mirror of the HMD) intersects this volume.

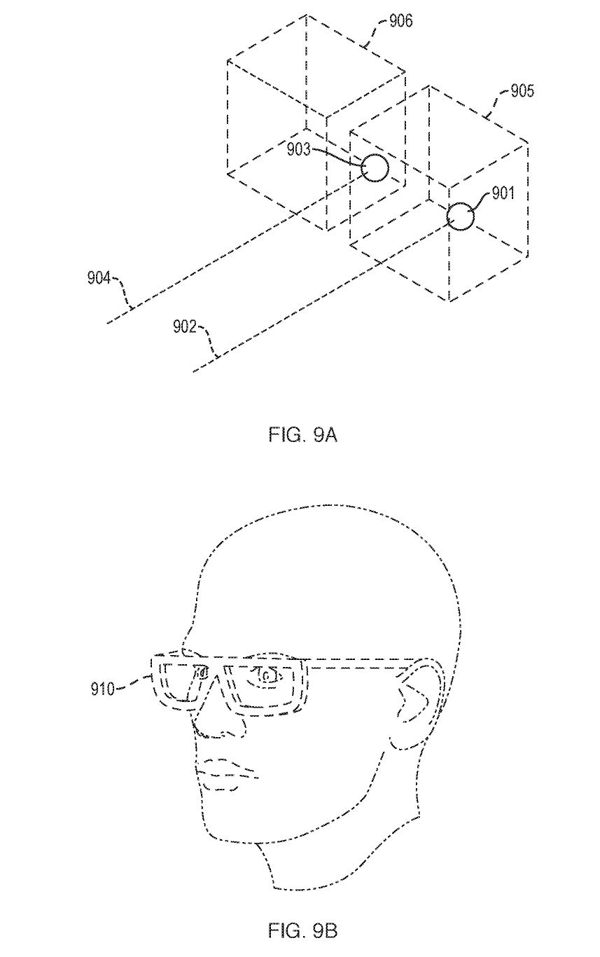

FIG. 9A shows a non-interference zone, which comprises a volume of space enclosed by two rectangular cuboids 905, 906. The pupils 901, 903 of the user's eyes are at the back of the cuboids 905, 906. The optical axis 904 of the user's right eye is at the bottom side of cuboid 906. The optical axis 902 of the user's left eye is at the bottom side of cuboid 905. FIG. 9B shows a frame zone 910.

### Obscuring the User's Face

A problem that confronted the inventors of this invention is how to reduce the portion of the user's face that is obscured when wearing the HMD. In illustrative implementations, this problem is solved by using one or more sets of multiple curved mirrors to deliver light from a source to the eyes. In illustrative implementations, a set of multiple curved mirrors: (a) creates a compactly folded optical path from a source to an eye, such that the mirror assembly obscures only a small portion of the user's face; and (b) rotates the image by an angle between 80 and 100 degrees. If the image source is a display screen of an MCD, such a rotation (of 80 degrees to 100 degrees) allows the display screen to be oriented facing straight down, plus or minus ten degrees. This is advantageous, because a display screen that is facing down (plus or minus ten degrees) obscures only a small portion of the user's face.

For example, if a smartphone that is about 0.27 inches deep is used as the image source, and the HMD supports the smartphone at forehead level with its screen facing down, then the smartphone itself obscures only a small strip of the user's forehead that is about 0.27 inches deep when viewed by another person looking at the user face-to-face. (In illustrative implementations, the HMD includes a structure to support the smartphone or other MCD. This support structure, too, obscures a small portion of the face. However, orienting the smartphone with its screen facing down—plus or minus ten degrees—tends to minimize the amount of the face obscured by this support structure).

In illustrative implementations, the right and light mirror carriages obscure only a small portion of a user's face. For example, in many cases, the carriages do not block a view of the user's brow, cheek, nose, eyes or mouth.

### Curved Image/Flat Image

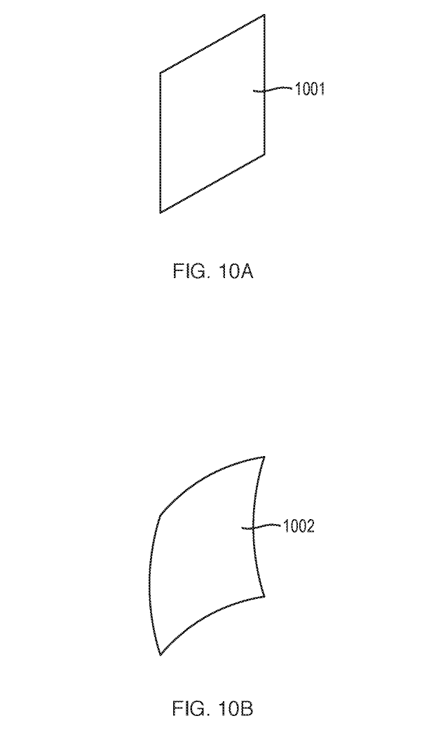

In some cases, the shape of an image presented to the entrance pupil is flat; in other cases, the image is curved. FIG. 10A shows a planar image 1001. FIG. 10B shows a curved image 1002. As used herein: (a) an image is “flat” or “planar” if its focal points are all disposed in a single plane; and (b) an image is “curved” or “non-planar” if its focal points are all disposed on a curved, non-planar surface. Thus, in some cases, each mirror assembly presents (to the entrance pupil of an eye) an image that is curved. In other cases, each mirror assembly presents (to the entrance pupil of an eye) an image that is flat.

A problem that confronted the inventors was how to reduce image distortion that otherwise occurs, in a flat image, when an eye rotates. In some implementations, this problem is solved or mitigated by presenting a curved image to an eye. For example, in some cases, the curved image is cylindrical; in other cases, the curved image has a spherical, ellipsoidal or any other curved (non-planar) shape. In other cases, it is desirable to present a flat image to an eye.

### Focal Length

In some implementations, one more actuators (e.g., 191, 192) translate a mirror carriage toward or away from the eye, in order to adjust the position at which the image is focused. For example, in some cases, one or more actuators translate the right and left carriages to a position where distance between the view mirror and the entrance pupil of the eye is equal to the focal distance of the view mirror.

### Convergence

In illustrative implementations, one or more actuators (e.g., 193, 194) rotate the mirror carriages inward (medially) or outward (laterally), in order to adjust for changing convergence of the human eyes. For example, in some cases, the actuators rotate the front (and to a lesser extent, the back) of the two carriage assemblies toward (or apart from) each other, in order to align with vergence of the eyes for a particular experience (such as vergence at 9 feet for Virtual Reality or vergence at 5 feet for Augmented Reality). In other cases, the actuators rotate the mirror carriages medially or laterally in order to adjust for temporally varying convergence of the user's eyes (even within a particular application, such as augmented reality).

Any type of actuator may be used to actuate this rotation of the carriages. Here are two non-limiting examples: In a first example, an actuator comprising an electro-active polymer, V-linkage and pivot is used to actuate this rotation of the carriages. The electro-active polymer changes size or shape in response to a change in applied electrical field. In a second example, an actuator comprising a dial, associated linkage and pivot is used to mechanically actuate this rotation of the carriages. A user turns the dial, which in turn imparts movement to the linkage and pivot, causing the rotation.

In some cases, one or more sensors (e.g. 195, 196, 543, 553) in an eye-tracking apparatus gather sensor data regarding the direction of gaze of the user's eyes. One or more computers (e.g., onboard the eye-tracking apparatus, or the MCD, or both): (a) analyze this sensor data in order to measure convergence of the eyes; (b) determine whether adjustment to convergence is needed (e.g., to achieve vergence at a particular depth for a particular application, such as Augmented Reality or Virtual Reality); and (c) output control signals to control this rotation of the carriages. In some cases, the eye-tracking apparatus measures eye rotation in any direction, but only a horizontal (medial/lateral) component of the rotation is taken into account for purposes of the vergence.

In some cases, the eye tracking apparatus includes infrared LEDs and an infrared sensor. In some cases, the IR LEDs and IR sensor are positioned in a carriage assembly such that they have a direct line of sight to the pupil of an eye, over a full range of rotational positions of the eye, which rotational positions would occur if the direction of gaze of the eye were to travel along a horizontal (medial/lateral) axis.

In some cases: (a) the eye-tracking apparatus includes a camera (e.g., 197) onboard the MCD and one or more light sources; and (b) light travels from an eye being tracked to the camera via a set of mirrors. For example, in some cases, light travels from an eye being tracked to a camera onboard the MCD via the right or left mirror assembly, a beam splitter and optionally additional optical elements.

### Inter-Pupillary Distance

In illustrative implementations, inter-pupillary distance (IPD) of the HMD is adjusted via movement (lateral or medial) of the right and left carriages.

In some cases, one or more actuators (e.g., 530) translate the right and left carriages to adjust the IPD of the HMD. Any type of actuator may be used. In some cases, the actuator comprises a mechanism powered by motion imparted by a human user. For example, in some cases, a user rotates a dial (e.g., 531), thereby imparting rotary motion that drives a gear assembly that moves the carriages right or left in equal displacements. Alternatively, an electrically-powered actuator (e.g., 532) translates the carriages to adjust IPD.

For example, in some cases, an actuator translates the right and left carriages either laterally or medially in order to align the centerline of each carriage with the center of a pupil. In alternative implementations, the images presented on the display are in a fixed location, and no such alignment is maintained.

Any type of actuator may be used to translate the carriages to adjust inter-pupillary distance (IPD). For example, in some cases, the actuator is a mechanism powered by motion imparted by a human (e.g., by a human turning a dial). Alternatively, in some cases, the actuator is electrically powered and is controlled by a computer (e.g., an integrated circuit or microcontroller). The control algorithm takes into account, among other things, feedback from sensors.

In alternative implementations, additional optical lens elements are used to effectively change inter-pupillary distance of the HMD. For example, in some cases, one or more actuators rotate wedge prisms in order to direct light to a mirror (e.g., a cheek mirror) that is aligned with the eye. Thus, in some cases, a wedge prism moves the image, instead of an actuator moving the carriages. The wedge prism moves the image by deflecting light. This ability (to use optical elements to effectively adjust IPD) is helpful in many user scenarios. For example, in some cases in which the entire display screen is taken for a display, using a wedge prism to effectively adjust IPD is advantageous (because, using the entire display screen would, in some cases, prevent an actual physical adjustment the IPD).

In some implementations, adjustments to account for differences in users' inter-pupillary distance are achieved by one or more of the following: (a) a computer (e.g., onboard the MCD) outputting control signals to move the position of the regions of the image source (e.g., regions of a display screen of an MCD) that emit light bound for the left or right eyes; (b) one or more actuators (e.g., 530) translating the left and right mirror assemblies relative to each other in order to change the physical distance between them; (c) positioning refractive or reflective optical elements (e.g., one or more prismatic wedges, spherical, cylindrical, torque or freeform lens, or Mangin mirrors), in addition to the curved mirrors, into an optical path between the image source and an eye; or (d) a computer (e.g., onboard the MCD) outputting control signals to pre-distort an image (e.g., to mitigate pincushion or barrel distortion).

### Correction of Aberrations/Compensation for Eye Movements

In some cases, in order to compensate for eye movements, a computer (e.g., onboard the MCD) outputs control signals to adjust an image displayed by an image source (e.g., a display screen), which in turn adjusts the image that is presented to the eye's pupil. For example, in some cases, the control signals control the size or shape of the image displayed by the image source, and thus indirectly control the size or shape of the presented image.

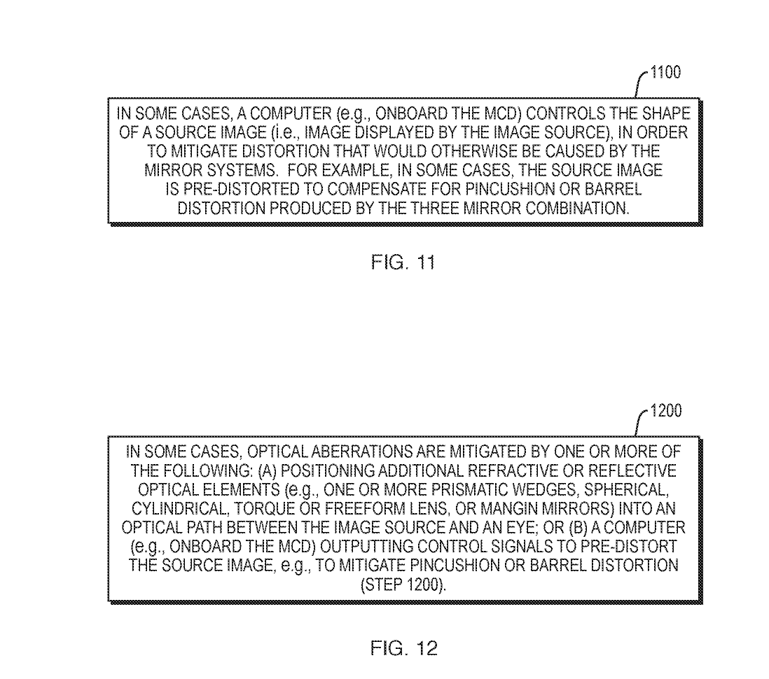

FIG. 11 shows a method of controlling distortion, in an illustrative implementation of this invention. In some cases, a computer (e.g., onboard the MCD) controls the shape of a source image (i.e., image displayed by the image source), in order to mitigate distortion that would otherwise be caused by the mirror systems. For example, in some cases, the source image is pre-distorted to compensate for pincushion or barrel distortion produced by the three mirror combination (Step 1100).

FIG. 12 shows another method of controlling distortion, in an illustrative implementation of this invention. In some implementations, optical aberrations are mitigated by one or more of the following: (a) positioning additional refractive or reflective optical elements (e.g., one or more prismatic wedges, spherical, cylindrical, torque or freeform lens, or Mangin mirrors) into an optical path between the image source and an eye; or (b) a computer (e.g., onboard the MCD) outputting control signals to pre-distort the source image, e.g., to mitigate pincushion or barrel distortion (Step 1200).

### Symmetry

In the example shown in FIG. 1, each of the mirrors (e.g., 121, 123, 125, 131, 133, 135) is curved. These mirrors may exhibit rotational symmetry, plane symmetry, no symmetry or any other form of symmetry.

Rotational symmetry: In some cases, the surface of at least one mirror in each mirror assembly (e.g., the right and left mirror assembly) is symmetric about a single axis. In some cases, that single axis may correspond (via ray tracing of field points) to a vertical axis of an image presented by the HMD to the entrance pupil of an eye of the user. In some cases, the single-axis symmetry is spherical. In other cases, the single-axis symmetry is aspherical (non-spherical).

Plane symmetry: In some cases, the surface of at least one mirror in each mirror assembly (e.g., the right and left mirror assembly) is symmetric about plane that is generally perpendicular to the mirror. In some cases, the plane corresponds (via ray tracing of field points) to a plane perpendicular to an image presented by the HMD to the entrance pupil of an eye of the user. In some cases, the plane symmetry is cylindrical or toroidal. In other cases, the plane symmetry is that of a polynomial curve rotated about an axis in the plane.

No symmetry (Freeform): In some cases, the surface of at least one mirror in each mirror assembly (e.g., the right and left mirror assembly) is not symmetric about any point. Examples of freeform surfaces include Zernike polynomial surfaces and bicubic, b-spline or NURBS surfaces.

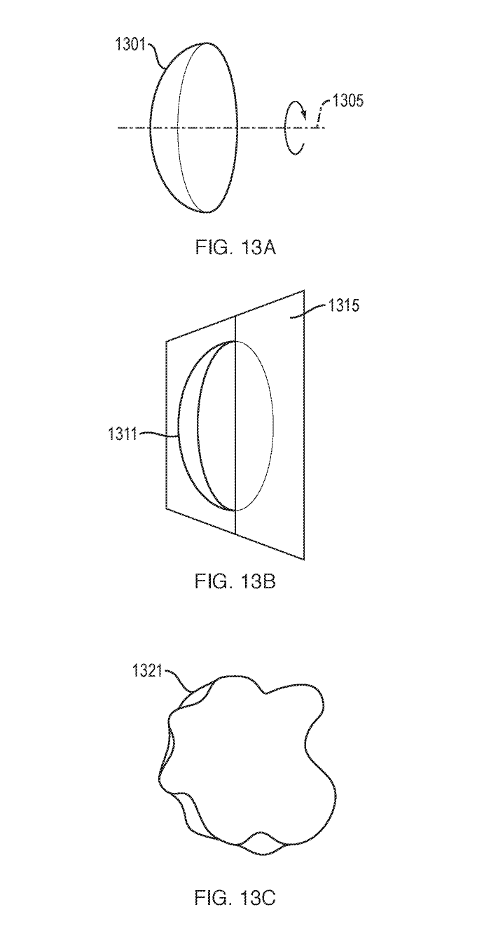

FIG. 13A shows a mirror 1301 with a single axis 1305 of symmetry. FIG. 13B shows a mirror 1311 with a plane 1315 of symmetry. FIG. 13C shows a mirror 1321 with no symmetry.

For purposes hereof, insignificant variations from perfect symmetry are ignored, as follows: An actual surface of an optical element is treated as being (i.e., conclusively deemed to be) a symmetric surface if all points of the actual surface are either (a) disposed on the symmetric surface or (b) are displaced from the symmetric surface by a distance that is less than or equal to one percent of the maximum dimension of the optical element.

In a prototype of this invention, each mirror in the right and mirror assemblies is plane symmetric, which plane corresponds (via ray tracing of field points) to a plane perpendicular to an image presented to the entrance pupil of an eye.

### Wireless Remote Controller

In some implementations, a wireless remote controller receives human input that controls an interactive display (such as a 3D game) that is displayed by the head mounted display. In some cases, the remote controller is a handheld device that includes: (a) one or more sensors (e.g., digital 3-axis accelerometer, digital 3-axis gyroscope, or inertial measurement unit) to detect position, orientation or motion of the controller; (b) a joystick; (c) trigger or other button; (d) one or more visual tags (also called fiducial markers) to facilitate tracking, by one or more cameras, of the position, motion or orientation of the remote controller; and (e) optionally, one or more haptic transducers for haptic feedback or haptic input. In some cases, the sensors onboard the remote controller include a 3-axis digital compass (or other magnetometer), a 3-axis gyroscope, a 3-axis accelerometer, or one or more inertial measurement units.

In some implementations, one or more cameras (e.g., 197) onboard the HMD (or the MCD) are used to track the position, orientation or motion of the remote controller. In some cases, the remote controller includes fiducial markers to facilitate this camera tracking; in other cases, the remote controller does not include fiducial markers. In some cases: (a) the HMD includes or is releasably attached to (and bears the weight of) an MCD (e.g., a smartphone); and (b) a camera onboard the MCD tracks the visual tag(s) on the remote controller. In some cases, a periscope (or other assembly of optical elements, including mirrors or lenses) is used to orient the camera's field of view toward a scene in which the remote controller is located.

In some cases, one or more computers (e.g., 141, 1412) execute algorithms: (i) to analyze data gathered by sensors onboard the remote controller or by a camera onboard the MCD or HMD; (ii) to determine (based at least in part on this data) position, orientation or motion of the remote controller; (iii) to associate the determined position, orientation or motion of the remote controller with an instruction or with data; and (iv) based (at least in part) on such instruction or data, to output control signals to control an interactive user display (e.g., a 3D game) that is displayed by the HMD to a user. For example, these one or more computers may be housed the remote controller or the MCD.

In illustrative implementations, the remote controller and MCD each include a wireless communication module (e.g., 1408), including a wireless receiver, transmitter or transceiver and an antenna.

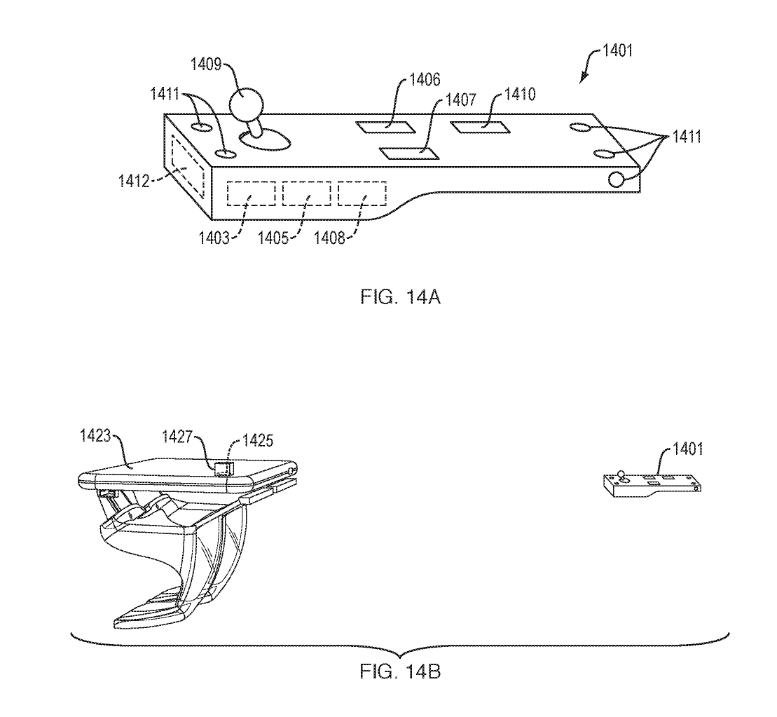

FIG. 14A shows a wireless remote controller 1401, in an illustrative implementation of this invention. The remote controller 1401 includes a joystick 1409 and buttons 1406, 1407 for accepting input from a human user, and a haptic transducer 1410 for providing haptic feedback to a user or accepting haptic input from the user. The remote controller 1401 includes one or more sensors (such as a digital 3-axis accelerometer, digital 3-axis gyroscope, or inertial measurement unit) (e.g., 1403, 1405) for detecting position, orientation or motion of the controller. In some cases, fiducial markers (e.g., 1411) on exterior surfaces of the remote controller facilitate optical tracking of the remote controller. The remote controller 1401 includes a computer 1412 (e.g., a microprocessor) for processing data, controlling the remote controller 1401 and interfacing with remote computers. The remote controller 1401 also includes a wireless communication module 1408.

FIG. 14B shows a wireless remote controller 1401 being tracked by a camera 1425 in a head-mounted display, in an illustrative implementation of this invention. For example, camera 1425 may be a second camera in a mobile computing device 1423 that is supported by the HMD 1433. A small periscope 1427 relays and rotates light, thereby providing to camera 1425 a view of the remote controller 1401.

### Other Angles of Rotation

This invention is not limited to rotating images by substantially ninety degrees. Instead, in some implementations, this invention rotates light by other net angles. For example, in some cases, this invention rotates light by substantially one hundred eighty degrees.

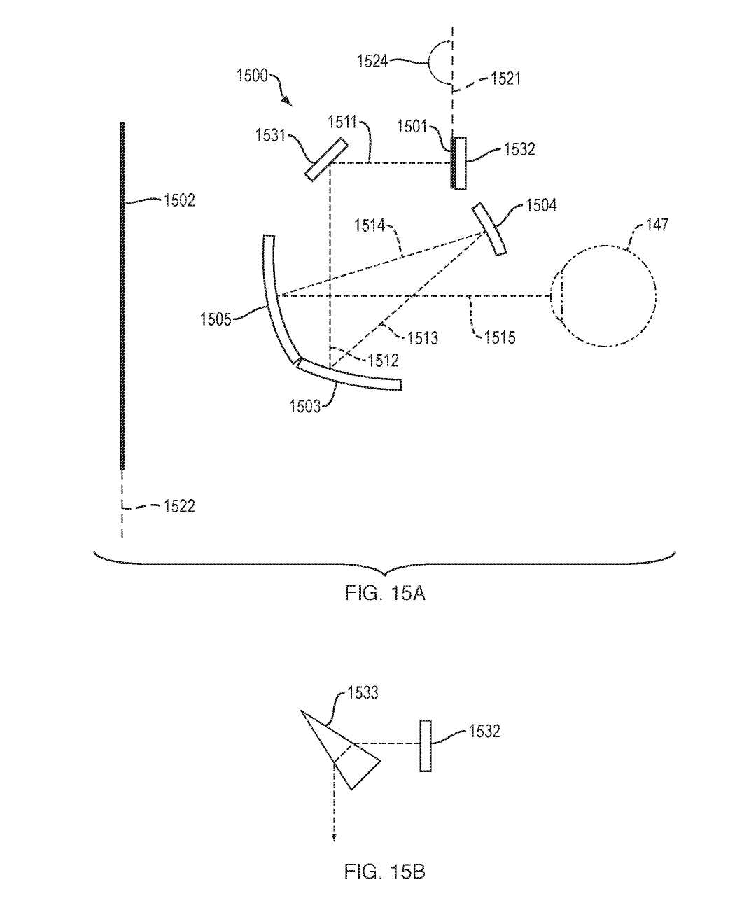

FIG. 15A shows an example of a four-mirror system 1500 that rotates light by a net amount of substantially 180 degrees. In FIG. 15A, mirrors 1531, 1503, 1504, 1505 relay light from the image source 1532 to an eye 147. The light travels in a folded optical path 1511, 1512, 1513, 1514, 1515 to the eye 147. Any one or more of mirrors 1531, 1503, 1504, 1505 may be curved. Alternatively, any one or more of mirrors 1531, 1503, 1504, 1505 may be planar. In FIG. 15A, a real image 1501 is displayed on the image source 1532 and is the optical object of the mirror system. Real image 1501 is oriented in a vertical plane. A virtual image 1502 produced by reflected light from the mirrors is oriented in a vertical plane.

For example, image source 1532 may comprise a micro-projector. Or, for example, image source 1532 may comprise a small display screen.

In FIG. 15A, angles 1524 is the angle between real image 1501 and virtual image 1502. Angle 1524 is substantially 180 degrees. The real image 1501 is oriented in a vertical direction 1521. The virtual image 1502 is oriented in a vertical direction 1522. The light that forms the real image 1501 (which is displayed on the image source) is traveling in a different direction than the light that enters the eye and creates the virtual image 1502. Specifically, the light that forms the real image 1501 is moving away from the user. The light that strikes the eye to create the virtual image 1502 is traveling toward the user.

The virtual image 1502 is not shown to scale in FIG. 15A: virtual image 1502 is larger than it appears to be in FIG. 15A. Also, the distance of virtual image 1502 from mirrors 1503, 1504, 1505 is not shown to scale in FIG. 15A: virtual image 1502 is further from mirrors 1503, 1504, 1505 than it appears to be in FIG. 5A.

Alternatively, mirror 1531 in FIG. 1 may be replaced by a small prism. FIG. 15B shows prism 1533 refracting light from an image source 1532, such that the light is diverted downward toward a cheek mirror.

### Field of Endeavor

In illustrative implementations, a field of endeavor of this invention is a head-mounted display with multiple curved mirrors, which curved mirrors taken together rotate an image.

### Computers

In exemplary implementations of this invention, one or more electronic computers (e.g., 141, 547, 557, 1412) are specially adapted: (1) to control the operation of, or interface with, hardware components, including any electronic visual display, projector, actuator, camera, sensor, or remote controller described above; (2) to analyze sensor data to determine position, orientation or motion of any object, including position, orientation or motion of a remote controller or of any actuator, mirror, set of mirrors or other component of a head-mounted display; (3) to analyze sensor data to track direction of gaze of an eye; (4) to perform any other calculation, including any computation, algorithm, program or software described or implied above; (5) to output signals for controlling transducers for outputting information in human perceivable format, and (6) to process data, to perform computations, to execute any algorithm or software, and to control the read or write of data to and from memory devices. The one or more computers may be in any position or positions within or outside of an HMD (or an MCD attached to the HMD). For example, in some cases (a) at least one computer is housed in or together with other components of the HMD or MCD, and (b) at least one computer is housed onboard a remote controller or is otherwise remote from other components of the HMD or MCD. The one or more computers are connected to each other or to other components in the HMD, MCD or remote controller either: (a) wirelessly, (b) by wired connection, or (c) by a combination of wired and wireless connections.

In exemplary implementations, one or more computers (e.g., 141, 547, 557, 1412) are programmed to perform any and all algorithms described or implied herein, and any and all functions described in the immediately preceding paragraph. For example, in some cases, programming for a computer is implemented as follows: (a) a machine-accessible medium has instructions encoded thereon that specify steps in an algorithm; and (b) the computer accesses the instructions encoded on the machine-accessible medium, in order to determine steps to execute in the algorithm. In exemplary implementations, the machine-accessible medium comprises a tangible non-transitory medium. In some cases, the machine-accessible medium comprises (a) a memory unit or (b) an auxiliary memory storage device. For example, while a program is executing, a control unit in a computer may fetch the next coded instruction from memory.

### Actuators

In illustrative implementations, each actuator (e.g., 191, 192, 193, 194, 530) for actuating movement is any kind of actuator, including a linear, rotary, electrical, piezoelectric, electro-active polymer, mechanical or electro-mechanical actuator. In some cases, the actuator includes and is powered by an electrical motor, including any stepper motor or servomotor. In some cases, the actuator includes a gear assembly, drive train, pivot, joint, rod, arm, or other component for transmitting motion. In some cases, one or more sensors are used to detect position, displacement or other data for feedback to one of more of the actuators. In some cases, an actuator comprises a mechanical actuator powered by motion imparted by a human (e.g., a dial, knob, button or slider that imparts motion, via a gear assembly, to one or more hardware components).

### DEFINITIONS

The terms “a” and “an”, when modifying a noun, do not imply that only one of the noun exists.

“Central point” of an area means: (a) if the area is a rectangle, a point in the area that is equidistant from the four corners of the rectangle; (b) if the area is a square, a point in the area that is equidistant from the four corners of the square; (c) if the area is a circle, a point in the area that is equidistant from all points of the circle; (d) if the area is an ellipse other than a circle, a point in the area that is located at the intersection of the major and minor axes of the ellipse; and (e) in all other cases, a point that is located at the centroid of the area.

The term “comprise” (and grammatical variations thereof) shall be construed as if followed by “without limitation”. If A comprises B, then A includes B and may include other things.

The term “computer” includes any computational device that performs logical and arithmetic operations. For example, in some cases, a “computer” comprises an electronic computational device, such as an integrated circuit, a microprocessor, a mobile computing device, a laptop computer, a tablet computer, a personal computer, or a mainframe computer. For example, in some cases, a “computer” comprises: (a) a central processing unit, (b) an ALU (arithmetic/logic unit), (c) a memory unit, and (d) a control unit that controls actions of other components of the computer so that encoded steps of a program are executed in a sequence. For example, in some cases, the term “computer” also includes peripheral units, including an auxiliary memory storage device (e.g., a disk drive or flash memory). However, a human is not a “computer”, as that term is used herein.

To say that a mirror is “curved” means that the mirror includes a non-planar reflective surface.

“Defined Term” means a term or phrase that is set forth in quotation marks in this Definitions section.

The term “e.g.” means for example.

The fact that an “example” or multiple examples of something are given does not imply that they are the only instances of that thing. An example (or a group of examples) is merely a non-exhaustive and non-limiting illustration.

Unless the context clearly indicates otherwise: (1) a phrase that includes “a first” thing and “a second” thing does not imply an order of the two things (or that there are only two of the things); and (2) such a phrase is simply a way of identifying the two things, respectively, so that they each can be referred to later with specificity (e.g., by referring to “the first” thing and “the second” thing later). For example, unless the context clearly indicates otherwise, if an equation has a first term and a second term, then the equation may (or may not) have more than two terms, and the first term may occur before or after the second term in the equation. A phrase that includes a “third” thing, a “fourth” thing and so on shall be construed in like manner.

As used herein, the “forehead” means the region of a human face that covers the frontal bone, including the supraorbital ridges.

The term “for instance” means for example.

“Frontal bone” means the os frontale.

As used herein, all directions (including “front”, “back”, “medial” and “lateral”) are determined from the perspective of the head of a user wearing the HMD. For example, something moves medially if it moves in a medial direction relative to the user's head. As used herein, “vertical” means along a line that is parallel to a superior/inferior axis of the user's head (as those terms are used in anatomical sense), and “horizontal” means along a line that is parallel to a lateral/medial axis of the user's head (as those terms are used in an anatomical sense). Thus, as used herein, directions are not determined by the user's environment. For example, vertical is not determined by the orientation of the local gravitational field; instead, vertical is determined by the superior/inferior axis of the user's head. A non-limiting example of “front” is: The “front” portion of a user's head includes the user's face. To say that a first thing is “in front of” a second thing means that the first thing is in front of at least a portion of the second thing.

“Herein” means in this document, including text and all patent drawings mentioned in the Brief Description of the Drawings. “Hereof” means of this document, including text and all patent drawings mentioned in the Brief Description of the Drawings.

Non-limiting examples of an “image source” include an electronic display screen and a projector.

As used herein: (1) “implementation” means an implementation of this invention; (2) “embodiment” means an embodiment of this invention; (3) “case” means an implementation of this invention; and (4) “use scenario” means a use scenario of this invention.

The term “include” (and grammatical variations thereof) shall be construed as if followed by “without limitation”.

“I/O device” means an input/output device. For example, an I/O device includes any device for (a) receiving input from a human, (b) providing to a human, or (c) both. For example, an I/O device includes a user interface, graphical user interface, keyboard, mouse, touch screen, microphone, handheld controller, display screen, speaker, or projector for projecting a visual display. Also, for example, an I/O device includes any device (e.g., button, dial, knob, slider or haptic transducer) for receiving input from, or providing output to, a human.

“Lens” means (a) a single lens, (b) a compound lens or (c) a set of multiple lenses.

The “maximum dimension” of an object is the longest Euclidian distance between any two points on the exterior surface of the object.

Non-limiting examples of a “mirror” include: (a) a mirror that is fully reflective; and (b) a mirror that is partially reflective and partially transmissive, such as a so-called half-silvered mirror.

An X, “out of” a set of X's, means an X that is an element of the set of X's. An X, “out of” multiple sets of X's, means an X that is an element of at least one of the sets of X's.

The term “mobile computing device” or “MCD” includes any of the following electronic devices: a smartphone, cell phone, mobile phone, phonepad, tablet, laptop, notebook, notepad, personal digital assistant, enterprise digital assistant, ultra-mobile PC, or any handheld computing device.

Non-limiting examples of an “optical element” include: (a) any solid or liquid object that reflects light; (b) any solid or liquid object that refracts light; or (c) a mirror, lens or pinhole mask.

The term “or” is inclusive, not exclusive. For example, A or B is true if A is true, or B is true, or both A or B are true. Also, for example, a calculation of A or B means a calculation of A, or a calculation of B, or a calculation of A and B.

A parenthesis is simply to make text easier to read, by indicating a grouping of words. A parenthesis does not mean that the parenthetical material is optional or can be ignored.

A “projector” means an optical device for projecting an image onto a surface that is not touching the optical device.

As used herein, a “set” is a group of one or more elements. As used herein, the term “set” does not include a so-called empty set (i.e., a set with no elements).

“Some” means one or more.

As used herein, a “subset” of a set consists of less than all of the elements of the set.

As used herein, “substantially ninety degrees” means in a range greater than or equal to 80 degrees and less than or equal to 100 degrees. “Substantially horizontal” means within ten degrees of horizontal. “Substantially vertical” means within ten degrees of vertical. “Substantially 180 degrees” means in a range greater than or equal to 160 degrees and less than or equal to 200 degrees. For example, an image that lies entirely in a vertical plane and that then changes orientation by 180 degrees still lies entirely in a vertical plane after the change, although the light comprising the image is traveling in a different direction after the change than before the change.

The term “such as” means for example.

Non-limiting examples of apparatus “worn on a head” include: (a) headwear worn directly on a head; and (b) apparatus that is physically attached to, or the weight of which is supported at least in part by, headwear worn directly on a head.

Except to the extent that the context clearly requires otherwise, if steps in a method are described herein, then: (1) steps in the method may occur in any order or sequence, even if the order or sequence is different than that described; (2) any step or steps in the method may occur more than once; (3) different steps, out of the steps in the method, may occur a different number of times during the method, (4) any step or steps in the method may be done in parallel or serially; (5) any step or steps in the method may be performed iteratively; (6) a given step in the method may be applied to the same thing each time that the particular step occurs or may be applied to different things each time that the given step occurs; and (7) the steps described are not an exhaustive listing of all of the steps in the method, and the method may include other steps.

This Definitions section shall, in all cases, control over and override any other definition of the Defined Terms. For example, the definitions of Defined Terms set forth in this Definitions section override common usage or any external dictionary. If a given term is explicitly or implicitly defined in this document, then that definition shall be controlling, and shall override any definition of the given term arising from any source (e.g., a dictionary or common usage) that is external to this document. If this document provides clarification regarding the meaning of a particular term, then that clarification shall, to the extent applicable, override any definition of the given term arising from any source (e.g., a dictionary or common usage) that is external to this document. To the extent that any term or phrase is defined or clarified herein, such definition or clarification applies to any grammatical variation of such term or phrase, taking into account the difference in grammatical form. For example, the grammatical variations include noun, verb, participle, adjective, or possessive forms, or different declensions, or different tenses. In each case described in this paragraph, Applicant is acting as Applicant's own lexicographer.

### VARIATIONS

This invention may be implemented in many different ways. Here are some non-limiting examples:

In some implementations, this invention is an apparatus comprising: (a) two sets of mirrors, each set of mirrors comprising three or more curved mirrors; and (b) a structure for supporting (i) the two sets of mirrors, and (ii) an image source; wherein (1) the apparatus is configured to be worn on the head of a user; and (2) each respective set of mirrors is configured to produce a virtual image that is rotated substantially ninety degrees relative to a real image displayed on the image source. In some cases: (a) the two sets of mirrors comprise a first set of mirrors and a second set of mirrors; (b) the first set of mirrors comprises a first mirror, second mirror and third mirror, positioned such that, when the apparatus is worn on the head, light travels from the image source to the first mirror, then to the second mirror, then to the third mirror, and then to a right eye of the user; and (c) the second set of mirrors comprises a fourth mirror, fifth mirror and sixth mirror, positioned such that, when the apparatus is worn on the head, light travels from the image source to the fourth mirror, then to the fifth mirror, then to the sixth mirror, and then to a left eye of the user. In some cases, when the apparatus is worn on the head: (a) the first and fourth mirrors are each positioned in front of, and at a vertical level of, a cheek of the user; (b) the second and fifth mirrors are each positioned in front of, and at a vertical level of, a forehead of the user; and (c) the third mirror and sixth mirrors are positioned in front of, and at a vertical level of, the right and left eyes, respectively. In some cases: (a) a positive lens that is rotationally symmetric is positioned in an optical path between the image source and the first mirror; and (b) another positive lens that is rotationally symmetric is positioned in an optical path between the image source and the fourth mirror. In some cases: (a) a positive lens that lacks rotational symmetry is positioned in an optical path between the image source and the first mirror; and (b) another positive lens that lacks rotational symmetry is positioned in an optical path between the image source and the fourth mirror. In some cases, a positive, decentered lens is positioned in an optical path between the image source and a mirror. In some cases, a positive lens: (a) is positioned in an optical path between a mirror and an area of the image source that is configured for displaying images; and (b) has an optical axis, which optical axis does not intersect a central point of the area. In some cases, the image source is a projector. Each of the cases described above in this paragraph is an example of the apparatus described in the first sentence of this paragraph, and is also an example of an embodiment of this invention that may be combined with other embodiments of this invention.

In some implementations, this invention is a head mounted display comprising: (a) an image source that comprises one or more display screens; (b) two sets of mirrors, such that each set of mirrors, respectively, comprises three mirrors; and (c) a structure for supporting (i) the two sets of mirrors and (ii) the image source; wherein each respective set of mirrors is configured to reflect light from the image source to an eye of the user, such that (1) light emitted by the image source along an optical axis of the respective set of mirrors travels in a first direction immediately after leaving the image source, (2) light that strikes the eye along an optical axis of the respective set of mirrors travels in a second direction immediately before striking the eye, and (3) the first and second directions differ by substantially 90 degrees. In some cases, the head-mounted display further comprises an actuator for rotating mirrors in a horizontal plane of rotation, to compensate for changing convergence of the eye. In some cases, a positive, decentered lens is positioned in an optical path between the image source and a mirror. In some cases, each given mirror out of the two sets of mirrors is configured to cause reflection of light from the image source, such that the reflection occurs at a non-planar, reflective surface of the given mirror. In some cases, for each specific mirror out of the two sets of mirrors, a reflective surface of the specific mirror is symmetric along only a single axis and not along any other axis. In some cases, for each particular mirror out of the two sets of mirrors, a reflective surface of the particular mirror is symmetric about a single plane and not about any other plane. Each of the cases described above in this paragraph is an example of the head-mounted display described in the first sentence of this paragraph, and is also an example of an embodiment of this invention that may be combined with other embodiments of this invention.

In some implementations, this invention is an apparatus comprising: (a) two sets of mirrors, each set of mirrors comprising three or more mirrors; and (b) a rigid structure for supporting (i) the two sets of mirrors and (ii) an image source for emitting light; wherein the apparatus is configured to be worn on the head of a user, such that (1) the image source is in front of the forehead of the user, and (2) each respective set of mirrors is positioned to reflect the light to an eye of a user. In some cases, the light exits the image source in a direction that includes a forward component. In some cases, each mirror, out of the two sets of mirrors, is curved. In some cases, each respective set of mirrors is configured to alter direction of the light such that: (a) a first ray of the light is traveling in a first direction immediately after the first ray exits the image source and a second ray of the light is traveling in a second direction immediately before the second ray enters the eye, and (b) the first and second directions differ by substantially one hundred eighty degrees. Each of the cases described above in this paragraph is an example of the apparatus described in the first sentence of this paragraph, and is also an example of an embodiment of this invention that may be combined with other embodiments of this invention.

In some implementations, this invention is a method comprising, in combination: (a) a first set of curved mirrors reflecting light from a first portion of one or more display screens, to produce a first virtual image that is visible to the right eye of a user; and (b) a second set of curved mirrors reflecting light from a second portion of the one or more display screens, to produce a second virtual image that is visible to the left eye of a user; wherein: (1) the one or more display screens and each set of mirrors are housed in a head-mounted display, (2) the one or more display screens are in front of the forehead of the user, (3) the first set of mirrors includes a first mirror in front of a right cheek of the user, a second mirror in front of the right side of the forehead, and a third mirror in front of the right eye, such that light travels from the first portion to the first mirror, then to the second mirror, then to the third mirror, and then to the right eye, and (4) the second set of mirrors includes a fourth mirror in front of a left cheek of the user, a fifth mirror in front of the left side of the forehead, and a sixth mirror in front of the left eye, such that light travels from the second portion to the fourth mirror, then to the fifth mirror, then to the sixth mirror, and then to the left eye. In some cases: (a) the first virtual image has a first orientation, the second virtual image has a second orientation, and the one or more display screens have a third orientation; and (b) the third orientation differs from each of the first and second orientations by substantially ninety degrees. Each of the cases described above in this paragraph is an example of the method described in the first sentence of this paragraph, and is also an example of an embodiment of this invention that may be combined with other embodiments of this invention.

While exemplary implementations are disclosed, many other implementations will occur to one of ordinary skill in the art and are all within the scope of the invention. Each of the various embodiments described above may be combined with other described embodiments in order to provide multiple features. This invention includes not only the combination of all identified features but also includes each combination and permutation of one or more of those features. Furthermore, while the foregoing describes a number of separate embodiments of the apparatus and methods of the present invention, what has been described herein is merely illustrative of the application of the principles of the present invention. Other arrangements, methods, modifications, and substitutions by one of ordinary skill in the art are therefore also within the scope of the present invention. Numerous modifications may be made by one of ordinary skill in the art without departing from the scope of the invention.

What is claimed is:

1. Apparatus comprising:
(a) two sets of mirrors, each set of mirrors comprising three or more curved mirrors; and
(b) a structure for supporting
(i) the two sets of mirrors, and
(ii) an image source;
wherein
(1) the apparatus is configured to be worn on the head of a user; and
(2) each respective set of mirrors is configured to produce a virtual image that is rotated substantially ninety degrees relative to a real image displayed on the image source.

2. The apparatus of claim 1, wherein:
(a) the two sets of mirrors comprise a first set of mirrors and a second set of mirrors;
(b) the first set of mirrors comprises a first mirror, second mirror and third mirror, positioned such that, when the apparatus is worn on the head, light travels from the image source to the first mirror, then to the second mirror, then to the third mirror, and then to a right eye of the user; and
(c) the second set of mirrors comprises a fourth mirror, fifth mirror and sixth mirror, positioned such that, when the apparatus is worn on the head, light travels from the image source to the fourth mirror, then to the fifth mirror, then to the sixth mirror, and then to a left eye of the user.

3. The apparatus of claim 2, wherein, when the apparatus is worn on the head:
(a) the first and fourth mirrors are each positioned in front of, and at a vertical level of, a cheek of the user;
(b) the second and fifth mirrors are each positioned in front of, and at a vertical level of, a forehead of the user; and
(c) the third mirror and sixth mirrors are positioned in front of, and at a vertical level of, the right and left eyes, respectively.

4. The apparatus of claim 2, wherein:
(a) a positive lens that is rotationally symmetric is positioned in an optical path between the image source and the first mirror; and
(b) another positive lens that is rotationally symmetric is positioned in an optical path between the image source and the fourth mirror.

5. The apparatus of claim 2, wherein:
(a) a positive lens that lacks rotational symmetry is positioned in an optical path between the image source and the first mirror; and
(b) another positive lens that lacks rotational symmetry is positioned in an optical path between the image source and the fourth mirror.

6. The apparatus of claim 1, wherein a positive, decentered lens is positioned in an optical path between the image source and a mirror.

7. The apparatus of claim 1, wherein a positive lens:
(a) is positioned in an optical path between a mirror and an area of the image source that is configured for displaying images; and
(b) has an optical axis, which optical axis does not intersect a central point of the area.

8. The apparatus of claim 1, wherein the image source is a projector.

9. A head mounted display comprising:
(a) an image source that comprises one or more display screens;
(b) two sets of mirrors, such that each set of mirrors, respectively, comprises three mirrors; and
(c) a structure for supporting (i) the two sets of mirrors and (ii) the image source;
wherein each respective set of mirrors is configured to reflect light from the image source to an eye of the user, such that
(1) light emitted by the image source along an optical axis of the respective set of mirrors travels in a first direction immediately after leaving the image source,
(2) light that strikes the eye along an optical axis of the respective set of mirrors travels in a second direction immediately before striking the eye, and
(3) the first and second directions differ by substantially 90 degrees.

10. The head-mounted display of claim 9, further comprising an actuator for rotating mirrors in a horizontal plane of rotation, to compensate for changing convergence of the eye.

11. The head mounted display of claim 9, wherein a positive, decentered lens is positioned in an optical path between the image source and a mirror.

12. The head mounted display of claim 9, wherein each given mirror out of the two sets of mirrors is configured to cause reflection of light from the image source, such that the reflection occurs at a non-planar, reflective surface of the given mirror.

13. The head mounted display of claim 9, wherein, for each specific mirror out of the two sets of mirrors, a reflective surface of the specific mirror is symmetric along only a single axis and not along any other axis.

14. The head mounted display of claim 9, wherein, for each particular mirror out of the two sets of mirrors, a reflective surface of the particular mirror is symmetric about a single plane and not about any other plane.

15. Apparatus comprising:
(a) two sets of mirrors, each set of mirrors comprising three or more mirrors; and
(b) a rigid structure for supporting (i) the two sets of mirrors and (ii) an image source for emitting light;
wherein the apparatus is configured to be worn on the head of a user, such that
(1) the image source is in front of the forehead of the user, and
(2) each respective set of mirrors is positioned to reflect the light to an eye of a user.

16. The apparatus of claim 15, wherein the light exits the image source in a direction that includes a forward component.

17. The apparatus of claim 15, wherein each mirror, out of the two sets of mirrors, is curved.

18. The apparatus of claim 15, wherein each respective set of mirrors is configured to alter direction of the light such that:
(a) a first ray of the light is traveling in a first direction immediately after the first ray exits the image source and a second ray of the light is traveling in a second direction immediately before the second ray enters the eye, and
(b) the first and second directions differ by substantially one hundred eighty degrees.

19. A method comprising, in combination:
(a) a first set of curved mirrors reflecting light from a first portion of one or more display screens, to produce a first virtual image that is visible to the right eye of a user; and
(b) a second set of curved mirrors reflecting light from a second portion of the one or more display screens, to produce a second virtual image that is visible to the left eye of a user;
wherein:
(1) the one or more display screens and each set of mirrors are housed in a head-mounted display,
(2) the one or more display screens are in front of the forehead of the user,
(3) the first set of mirrors includes a first mirror in front of a right cheek of the user, a second mirror in front of the right side of the forehead, and a third mirror in front of the right eye, such that light travels from the first portion to the first mirror, then to the second mirror, then to the third mirror, and then to the right eye, and
(4) the second set of mirrors includes a fourth mirror in front of a left cheek of the user, a fifth mirror in front of the left side of the forehead, and a sixth mirror in front of the left eye, such that light travels from the second portion to the fourth mirror, then to the fifth mirror, then to the sixth mirror, and then to the left eye.

20. The method of claim 19, wherein:
(a) the first virtual image has a first orientation, the second virtual image has a second orientation, and the one or more display screens have a third orientation; and
(b) the third orientation differs from each of the first and second orientations by substantially ninety degrees.
